(19) United States
(12) Patent Application Publication
(10) Pub. No.: US 2003/0234715 A1
(43) Pub. Date: Dec. 25, 2003

(54) Ignition system coil assembly featuring flexible ring terminal interconnects

(76) Inventor: David Lee Clute, Pendleton, IN (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/177,361

(22) Filed: Jun. 21, 2002

(51) Int. Cl. H01F 27/29

(52) U.S. Cl. 336/192

(57) ABSTRACT

An ignition system coil assembly featuring flexible ring terminals for providing interconnections between a secondary coil and tower terminals. A case carries a pair of tower terminals for interfacing with respective spark plug wires, the case having a coil receptacle. A coil package is collectively formed of a tube carrying the secondary coil, a pair of flexible ring terminals, one flexible ring terminal being located at each end of the tube, and a concentrically disposed primary coil. The coil package is slipped into the cylindrical coil receptacle. The tube has an annular locating abutment near each end which positions the tube within the coil receptacle. Each flexible ring terminal has a hollow cross-sectioned annular configuration, wherein the electrically conductive ring terminal sidewall has a discontinuity for facilitating resilient flexing against the contact surface of its respective tower terminal

### TECHNICAL FIELD

The present invention relates to automotive ignition systems, particularly the ignition coil assembly thereof. More particularly, the present invention relates to a flexible ring-shaped terminal for interfacing the secondary wire spool of the ignition coil to a respective tower terminal of the ignition system.

### BACKGROUND OF THE INVENTION

Automotive ignition systems utilize an ignition coil for providing the high voltages necessary to induce sparking at the spark plugs. The ignition coil has a primary wire spool, referred to simply hereinafter as the “primary coil” and a secondary wire spool, referred to hereinafter simply as the “secondary coil”. The primary coil usually has an iron core to increase the magnetic field strength produced thereby, wherein pulsations in this magnetic field induce an applied electromotive force (EMF) in the secondary coil. Because the number of turns of the secondary coil is far greater than the number of turns of the primary coil, the voltage (for example 20 kV) of the EMF of the secondary coil is considerably higher than the input voltage (for example 12 V) of the primary coil.

Each of the spark plug wires of the ignition system connect to a respective tower terminal of the electrical system. In regard to this interconnection, the tower terminals are mounted to a dielectric (ie., plastic) base and are connected to the secondary coil. Each tower terminal has an exposed male pin terminal for snappingly interfacing with a female socket terminal of the spark plug wire.

The conventional secondary coil interconnect has a number of deficiencies, among these include an excessive area requiring large cross-sections of potting material; little protection from dendrite; excessive assembly steps; limited multiplicity of possible applications due to the secondary coil being non-symmetrical; specialization of the connection interface, which reduces options available for a common case envelope; and complications associated with the molds for the plastic components.

Accordingly, what remains needed in the art is an interconnection interface between the secondary coil and the tower terminals of an automotive ignition system which has none of the above described deficiencies.

### SUMMARY OF THE INVENTION

The present invention is a coil assembly featuring flexible ring terminals for providing interconnections between a secondary coil and tower terminals of, for example, an automotive ignition system, the ignition coil assembly having the advantages of: the possibility of multiple applications in that the secondary coil may be symmetrical, and the case may be configured common among the applications; minimization of cross-section and, therefore, minimization of potting; elimination of sharp edges, thereby eliminating dendrite; simple and few assembly operations; and simplification of the components.

The flexible ring terminal according to the present invention has a hollow cross-sectioned annular configuration, wherein the electrically conductive ring terminal sidewall has a discontinuity for facilitating resilient flexing.

In a first embodiment, the sidewall defines a hollow cross-section characterized by left and right arcuate ends, an annular apex at an outer face, an inner face having an annular slot formed therein, wherein the annular slot is located adjacent one of the arcuate ends.

In a second embodiment, the sidewall defines a hollow cross-section defined by an inner face, an arcuate end, and an outer face connected to the inner face by the arcuate end, wherein opposite the arcuate end the outer face is shaped so that an end portion thereof abuts an end portion of the inner face. In a third embodiment.

In a third embodiment, the sidewall defines a hollow cross-section characterized by left and right arcuate ends, an annular apex at an outer face, an inner face having an annular slot formed therein, wherein the annular slot is located medially between the arcuate ends.

In a fourth embodiment, the sidewall defines a hollow cross-section defined by an inner face, an arcuate end, and an outer face connected to the inner face by the arcuate end, wherein opposite the arcuate end the outer face is shaped so that a bent-back end portion thereof abuts a bent-back end portion of the inner face.

The ring terminal is slipped onto an end of a tube, wherein preferably a ring terminal is slipped onto each of the opposed ends of the tube, and wherein the tube carries the secondary coil. Each end of the secondary coil is connected to a respective flexible ring terminal. A coil package is collectively formed of the tube with its secondary coil, the flexible ring terminals and a concentrically disposed primary coil (and its ferromagneitc core). The coil package is slipped into a cylindrical coil receptacle of a dielectric (ie., plastic) case. The tube has an annular locating abutment near each end which positions the tube within the coil receptacle.

The case carries a tower terminal for each ring terminal, wherein the contact surface of each tower terminal respectively contacts its ring terminal. In this regard, the ring terminals are resiliently compressed so as to apply contact pressure with respect to the contact surface of each of the tower terminals. The case further has a tower terminal receptacle respectively for each tower terminal such that an exposed male pin terminal of each tower terminal is snappingly interfaced with a female socket terminal of a respective spark plug wire.

Accordingly, it is an object of the present invention to provide a flexible ring shaped interconnection between a secondary coil and one or more tower terminals.

It is an additional object of the present invention to provide a coil assembly of an ignition system, the coil assembly featuring a flexible ring shaped interconnection between its secondary coil and one or more tower terminals thereof.

These and additional objects, features and advantages of the present invention will become clearer from the following specification of a preferred embodiment.

### BRIEF DESCRIPTION OF THE DRAWINGS

FIG. 1 is a partly sectional side view of a coil assembly according to the present invention, wherein a flexible ring terminal according to a first embodiment of the present invention is depicted.

FIG. 2 is an end view seen along line 2-2 of FIG. 1.

FIG. 3 is a perspective view of the flexible ring terminal depicted at FIGS. 1 and 2.

FIG. 4 is a sectional view of the flexible ring terminal seen along line 4-4 of FIG. 3.

FIG. 5A is a perspective view of a second embodiment of a flexible ring terminal according to the present invention.

FIG. 5B is a top plan view of the flexible ring terminal of FIG. 5A.

FIG. 5C is a sectional view seen along line 5C-5C of FIG. 5A.

FIG. 6A is a perspective view of a third embodiment of a flexible ring terminal according to the present invention.

FIG. 6B is a sectional view seen along line 6B-6B of FIG. 6A.

FIG. 7A is a perspective view of a fourth embodiment of a flexible ring terminal according to the present invention.

FIG. 7B is a sectional view seen along line 7B-7B of FIG. 7A.

### DESCRIPTION OF THE PREFERRED EMBODIMENT

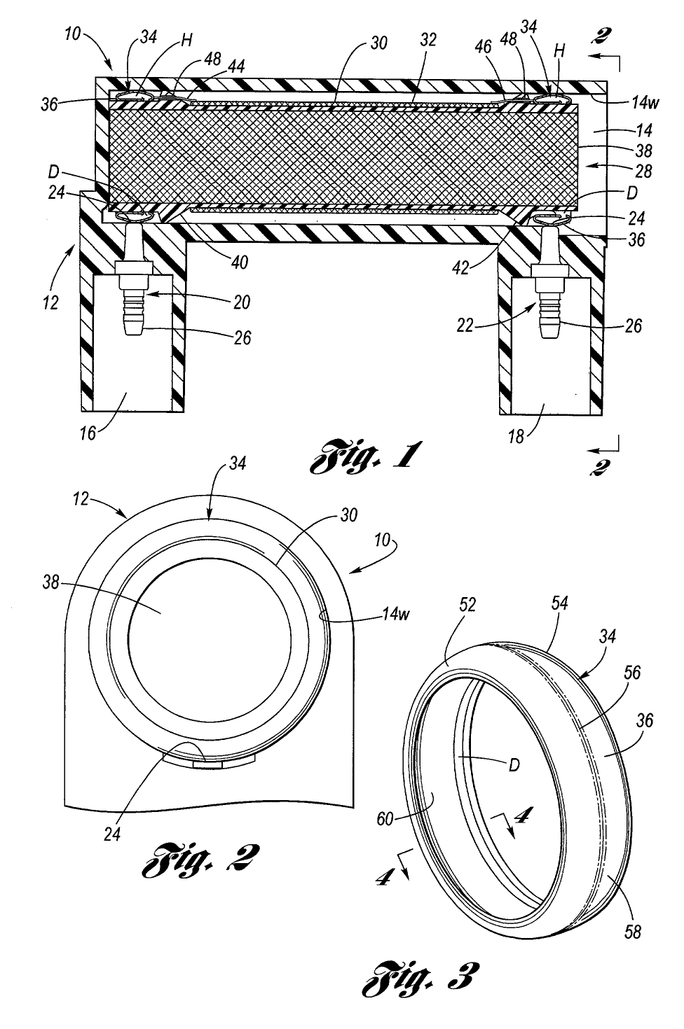

Referring now to the Drawing, FIGS. 1 and 2 depict an example of an ignition system coil assembly 10 according to the present invention. The coil assembly 10 includes a dielectric (for example, plastic) case 12 having a cylindrical coil receptacle 14 and a pair of tower terminal receptacles 16, 18. The coil assembly 10 further includes a pair of tower terminals 20, 22 partly embedded in the case 12, wherein one tower terminal is respectively located at each tower terminal receptacle 16, 18 such that a contact surface 24 is exposed at the coil receptacle 14 and a male pin terminal 26 is exposed in its respective tower terminal receptacle such that a female socket of a spark plug wire may be snapped respectively thereupon in a manner well known in the art.

The coil assembly 10 further includes a coil package 28, which, in turn, includes a dielectric (for example, plastic) tube 30; a secondary coil 32 wound on the tube; a pair of flexible ring terminals 34 mounted upon the tube at respectively opposing ends thereof; and a primary coil 38 disposed concentrically inside the tube, wherein the primary coil typically includes a ferromagnetic core. The secondary coil 32 has a larger number of turns than the primary coil 38 dependent upon the voltage step-up desired.

Operatively, the primary coil 38 is connected to an interrupting source of low voltage which produces a pulsating magnetic field through the secondary coil 32 such as to thereby create an induced EMF in the secondary coil. The EMF provides a very high voltage in the secondary coil sufficient to achieve spark plug sparking. In this regard, each of the male pin terminals 26 is snappingly connected to a respective female socket of a spark plug wire, wherein each spark plug wire is connected, in turn, to a spark plug.

A key aspect of the present invention is the interface of the secondary coil 32 with the tower terminals 20, 22 via the electrically conductive flexible ring terminals 34. The flexible ring terminals 34 have an annular shape with an inside circumference for snuggly fitting upon the cylindrical shape of the tube 30. Each flexible ring terminal 34 has a sidewall 36 providing an annular hollow H, wherein an annular discontinuity D is formed in the sidewall which allows for a resilient compressibility of the sidewall in the radial direction.

The placement of the tube 30 into the coil receptacle 14 is accompanied by the flexible ring terminals 34 compressing against the receptacle wall 14w, as well as against the contact surface 24 of the respective tower terminals 20, 22. In this regard, the tube 30 is provided with annular locating abutments 40, 42, one abutment near each end, which serve to abut the receptacle wall 14w and thereby centrally locate the tube with respect to the coil receptacle. The locating abutments 40, 42 may also serve to aid locating of the flexible ring terminals with respect to the tube, and thereby, with respect to the contact surfaces 26. Each of the flexible ring terminals 34 are electrically connected to a respective end of the secondary coil via a respective shunt 44, 46, each shunt passing respectively through a passage 48 formed in the locating abutments 40, 42.

Four preferred examples of configuration of the flexible ring terminals 34 are presented hereinafter, the first being most preferred.

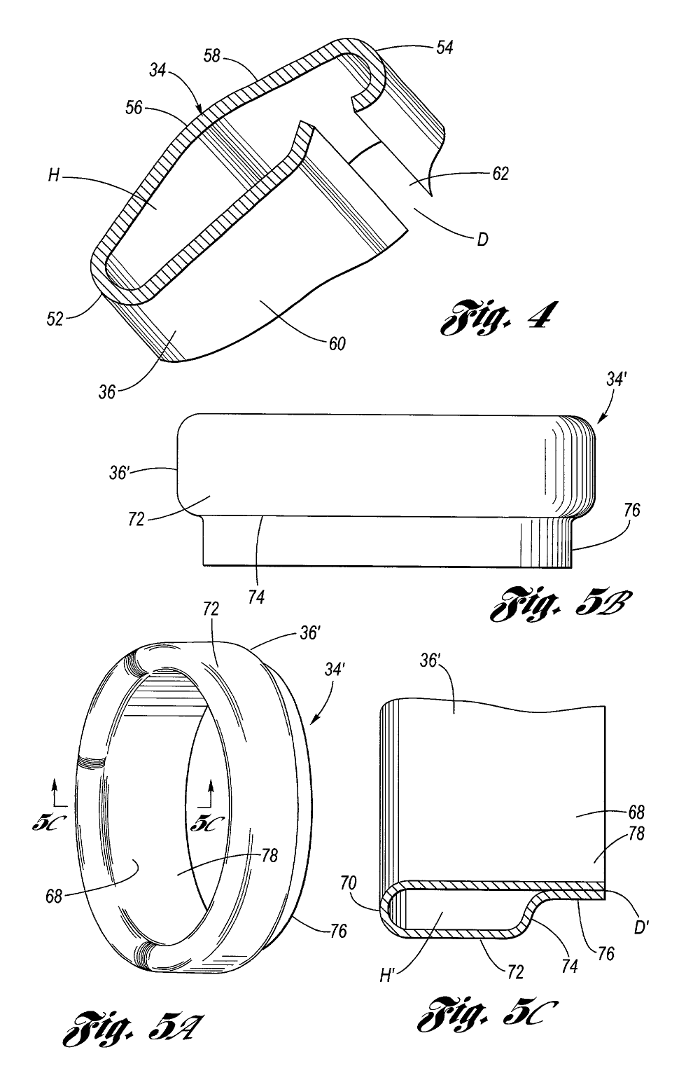

In a first embodiment of a flexible ring terminal 34, as shown at FIGS. 1 through 4, a sidewall 36 defines a hollow H characterized by left and right arcuate ends 52, 54, an annular apex 56 at an outer face 58, an inner face 60 having an annular discontinuity D in the form of an annular slot 62 formed in the inner face, wherein the annular slot is located adjacent one of the arcuate ends 54. At the slot 62, the sidewall edge 64 at both sides of the slot are turned inwardly. In operation as shown at FIG. 1, the inner face 60 abuts the tube 30 and the annular apex 56 abuts the contact surface 26.

In a second embodiment of a flexible ring terminal 34′, as shown at FIGS. 5A through 5C, a sidewall 36″ defines a hollow H″ characterized by an inner face 68, an arcuate end 70, and an outer face 72 connected to the inner face by the arcuate end. Distally from the arcuate end 70, the outer face 72 has an S-shaped contour 74 such that an end portion 76 thereof abuts an end portion 78 of the inner face 68. In this case, the annular discontinuity D′ is in the form of the unattached abutment of the end portions 76, 78. In operation, the inner face 68 abuts the tube 30 and the outer face between the arcuate end 70 and the S-shaped contour abuts the contact surface 26.

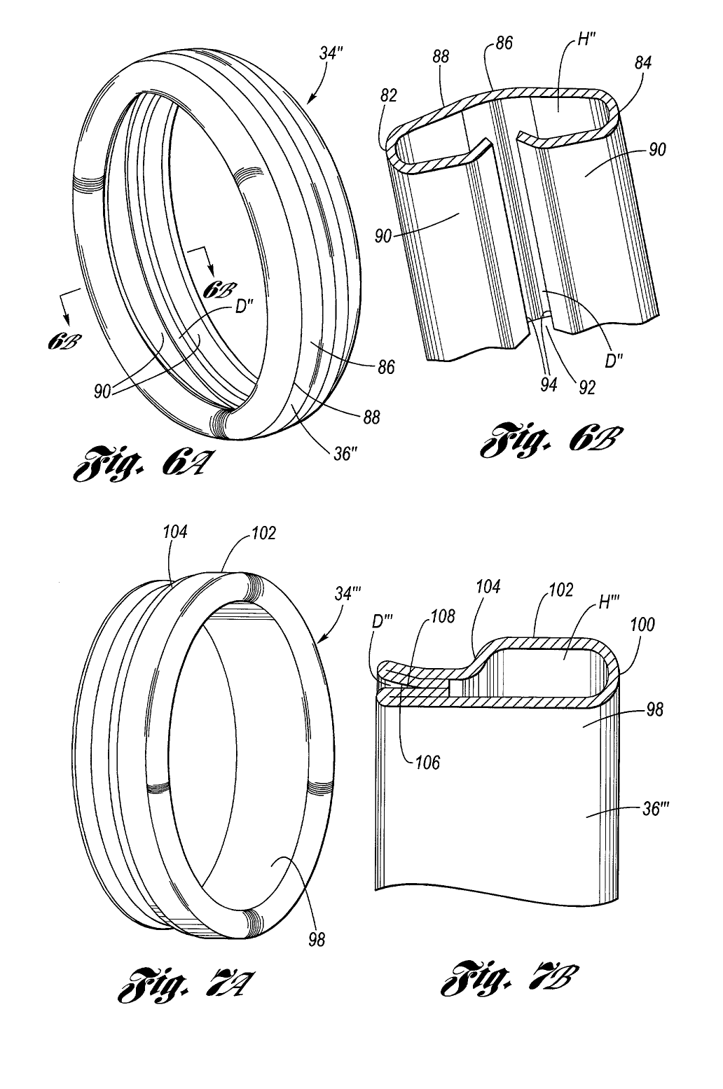

In a third embodiment of a flexible ring terminal 34″, as shown at FIGS. 6A and 6B, a sidewall 36″ defines a hollow H″ characterized by left and right arcuate ends 82, 84, an annular apex 86 at an outer face 88, an inner face 90 having an annuklar discontinuity D″ in the form of an annular slot 92 formed in the inner face, wherein the annular slot is located medially between the arcuate ends. At the slot 92, the sidewall edge 94 at both sides of the slot are turned inwardly. In operation, the inner face 90 abuts the tube 30 and the annular apex 86 abuts the contact surface 26.

In a fourth embodiment of a flexible ring terminal 34′″, as shown at FIGS. 7A and 7B, a sidewall 36′″ defines a hollow H′″ characterized by an inner face 98, an arcuate end 100, and an outer face 102 connected to the inner face by the arcuate end. Distally from the arcuate end 100, the outer face 102 has an S-shaped contour 104 such that a bent-back end portion 106 thereof abuts a back-bent end portion 108 of the inner face 98. In this case, the annular discontinuity D′″ is in the form of the unattached abutment of the bent-back end portions 106, 108. In operation, the inner face 98 abuts the tube 30 and the outer face between the arcuate end 100 and the S-shaped contour abuts the contact surface 26.

To those skilled in the art to which this invention appertains, the above described preferred embodiment may be subject to change or modification. Such change or modification can be carried out without departing from the scope of the invention, which is intended to be limited only by the scope of the appended claims.

1. A coil assembly for an ignition system comprising:
a dielectric case comprising a coil receptacle, and at least one tower terminal receptacle;
at least one tower terminal located in said at least one tower terminal receptacle, said at least one terminal receptacle having a contact surface exposed at said coil receptacle;
a coil package comprising a tube and a secondary coil wound on said tube; and
at least one flexible ring terminal mounted on said tube, wherein said flexible ring terminal is connected to said secondary coil and contacts the contact surface of a respective tower terminal.

2. The coil assembly of claim 1, wherein said at least one tower terminal comprises two terminal towers; said at least one flexible ring terminal comprising two flexible ring terminals; one flexible ring terminal being located at each end of said tube; wherein each flexible ring terminal contacts the contact surface of a respective tower terminal.

3. The coil assembly of claim 2, wherein each said flexible ring terminal comprises an annularly shaped sidewall defining a hollow, said sidewall having an annular discontinuity formed therein, wherein said discontinuity provides said sidewall with a resiliency with respect to a radial compression.

4. The coil assembly of claim 3, wherein each said flexible ring terminal comprises:
said sidewall comprising a left arcuate end; a right arcuate end; an outer face between said left and right arcuate ends, wherein said outer face has an annular apex; an inner face having an annular discontinuity formed therein, said annular discontinuity comprising an annular slot located adjacent one of said left and right arcuate ends, and wherein said sidewall at said slot is turned inwardly at each side of said slot; and
wherein the inner face abuts the tube, and wherein the annular apex abuts the contact surface of a respective tower terminal.

5. The coil assembly of claim 3, wherein each said flexible ring terminal comprises:
said sidewall comprising an inner face; an arcuate end; and an outer face connected to the inner face by the arcuate end; wherein distally from the arcuate end the outer face has a generally S-shaped contour such that an end portion thereof abuts an end portion of the inner face; wherein an annular discontinuity comprises a mutually unattached abutment of the end portions; and
wherein the inner face abuts the tube, and wherein a respective said contact surface contacts the outer face between said generally S-shaped contour and said arcuate end.

6. The coil assembly of claim 3, wherein each said flexible ring terminal comprises:
said sidewall comprising a left arcuate end; a right arcuate end; an outer face between said left and right arcuate ends, wherein said outer face has an annular apex; an inner face having an annular discontinuity formed therein, said annular dicontinuity comprising an annular slot located medially between said left and right arcuate ends, and wherein said sidewall at said slot is turned inwardly at each side of said slot; and
wherein the inner face abuts the tube, and wherein the annular apex abuts the contact surface of a respective tower terminal.

7. The coil assembly of claim 3, wherein each said flexible ring terminal comprises:
said sidewall comprising an inner face; an arcuate end; and an outer face connected to the inner face by the arcuate end; wherein distally from the arcuate end the outer face has a generally S-shaped contour such that a bent-back end portion thereof abuts a bent-back end portion of the inner face; wherein an annular discontinuity comprises a mutually unattached abutment of the bent-back end portions; and
wherein the inner face abuts the tube, and wherein a respective said contact surface contacts the outer face between said generally S-shaped contour and said arcuate end.

8. A flexible ring terminal for a coil assembly, comprising:
an annularly shaped sidewall defining a hollow, said sidewall having an annular discontinuity formed therein, wherein said discontinuity provides said sidewall with a resiliency with respect to a radial compression.

9. The flexible ring terminal of claim 8, wherein said sidewall comprises a left arcuate end; a right arcuate end; an outer face between said left and right arcuate ends, wherein said outer face has an annular apex; an inner face having an annular discontinuity formed therein, said annular discontinuity comprising an annular slot located adjacent one of said left and right arcuate ends; and wherein said sidewall at said slot is turned inwardly at each side of said slot.

10. The flexible ring terminal of claim 8, wherein said sidewall comprises an inner face; an arcuate end; and an outer face connected to the inner face by the arcuate end; wherein distally from the arcuate end the outer face has a generally S-shaped contour such that an end portion thereof abuts an end portion of the inner face; and wherein an annular discontinuity comprises a mutually unattached abutment of the end portions.

11. The flexible ring terminal of claim 8, wherein said sidewall comprises a left arcuate end; a right arcuate end; an outer face between said left and right arcuate ends, wherein said outer face has an annular apex; an inner face having an annular discontinuity formed therein, said annular discontinuity comprising an annular slot located medially between said left and right arcuate ends; and wherein said sidewall at said slot is turned inwardly at each side of said slot.

12. The flexible ring terminal of claim 8, wherein said sidewall comprises an inner face; an arcuate end; and an outer face connected to the inner face by the arcuate end; wherein distally from the arcuate end the outer face has a generally S-shaped contour such that a bent-back end portion thereof abuts a bent-back end portion of the inner face; and wherein an annular discontinuity comprises a mutually unattached abutment of the bent-back end portions.
